(19) United States
(12) Patent Application Publication
(10) Pub. No.: US 2025/0018721 A1
(43) Pub. Date: Jan. 16, 2025

(54) INK CARTRIDGE AND INKJET RECORDING DEVICE INCLUDING INK CARTRIDGE

(71) Applicant: Roland DG Corporation, Hamamatsu-shi (JP)

(72) Inventors: Teppei SAWADA, Hamamatsu-shi (JP); Risa HATTORI, Hamamatsu-shi (JP); Satoshi HIRAIDE, Hamamatsu-shi (JP); Akihiro SUZUKI, Hamamatsu-shi (JP); Yuki TOMITA, Hamamatsu-shi (JP)

(21) Appl. No.: 18/899,804

(22) Filed: Sep. 27, 2024

Related U.S. Application Data
(63) Continuation of application No. PCT/JP2022/016706, filed on Mar. 31, 2022.

(51) Int. Cl. B41J 2/175

(52) U.S. Cl. CPC B41J 2/17513; B41J 2/1754; B41J 2/17553; B41J 2002/17516

(57) ABSTRACT

An ink cartridge includes a box body including a bottomed box main body with an aperture on the top surface and a lid covering the aperture, a bag body fixed inside the box main body and including ink inside, a plate including at least one folded portion and a first flat portion and a second flat portion defined by a fold at the folded portion, the bag body is adhered to an upper surface of the first flat portion, and when the box body is closed, an end of the second flat portion is in contact with a corner of the box main body and the lid, and the first flat portion is in contact with the bottom surface of the box main body.

### CROSS REFERENCE TO RELATED APPLICATIONS

This application is a Continuation Application of PCT Application No. PCT/JP2022/016706 filed on Mar. 31, 2022. The entire contents of this application are hereby incorporated herein by reference.

### BACKGROUND OF THE INVENTION

### 1. Field of the Invention

The present invention relates to ink cartridges and inkjet recording devices including ink cartridges, and particularly to ink cartridges each including a bag body including ink in a box main body and inkjet recording devices including ink cartridges.

### 2. Description of the Related Art

Conventionally, ink cartridges for supplying ink to inkjet recording devices such as inkjet printers have had an ink pouch containing ink fixed inside the case with a double-sided tape.

When the ink in the ink cartridge is empty, the ink cartridge has been replaced with a new one along with the ink pouch and case.

However, in recent years, there has been a need to reuse a case of the ink cartridge from the viewpoint of reducing environmental impact and cost.

Japanese Patent No. 5960423 describes an ink cartridge in which a fixing plate is interposed between an ink pouch and a case, the ink pouch is adhered to the fixing plate, and a protrusion of the fixing plate is inserted into the gap between a rib disposed on the case and a case-side plate to fix the ink pouch in a predetermined place in the case via the fixing plate.

According to the ink cartridge of Japanese Patent No. 5960423, when replacing the ink pouch, the fixing plate can be pulled out from the gap between the rib and the case-side plate, and the ink pouch can be removed from the case with the fixing plate and replaced with a new ink pouch.

### SUMMARY OF THE INVENTION

However, according to the ink cartridge of Japanese Patent No. 5960423, the protrusion of the fixing plate is fitted into the gap between the rib and the case-side plate, so that the operation of inserting/removing the ink pouch is not easy for general users. In order to make a cartridge whose ink pouch is replaceable, it is required that anyone can easily replace it. Further, according to Japanese Patent No. 5960423, since the ink pouch is fixed by the fixing plate which is a single flat plate, it is required to use a rigid plate material as the fixing plate.

Example embodiments of the present invention provide ink cartridges that each allow an ink pouch to be easily replaced and includes a fixing plate enabling the ink pouch to be fixed even if a plate material has poor rigidity, and also provide inkjet printers including the ink cartridges.

An ink cartridge according to an example embodiment of the present invention includes a box body including a box main body with an aperture and a lid covering the aperture, and a bag body inside the box body and including ink inside, wherein the ink cartridge includes a plate including at least one folded portion and a first flat portion and other flat portion(s) defined by at least one fold at the folded portion, the bag body is adhered to one side surface of the first flat portion, and at least a portion of the other flat portion(s) is positioned on the one side surface, and a length of the other flat portion(s) when viewed from a direction parallel to the one side surface of the first flat portion in a state where the plate and the bag body are in the box body is equal to a length of an area in which the flat portion is inside the box body when viewed from a direction parallel to the one side surface of the first flat portion.

According to the above-mentioned ink cartridge, when the box body is closed, at least one end of the other flat portion of the plate is in contact with a corner portion of the box main body and the lid, and a first flat portion is in contact with the bottom surface of the box main body, so that opening the lid releases the first flat portion from contacting the bottom surface of the box main body. Therefore, opening/closing of the box releases/fixes the fixed installation of the first flat portion to which the bag body is adhered, to the box main body to make it easy for general users to replace the bag body (ink).

In addition, since the bag body including ink is held by a plate folded at least once, the rigidity of the plate is increased compared to using a conventional single-plate fixing plate, and thus the physical properties of the plate are substituted with a material with lower rigidity than the conventional one.

According to example embodiments of the present invention, it is possible to provide ink cartridges that each allow ink to be easily replaced and includes a fixing plate enabling an ink pouch to be fixed even if a plate material has poor rigidity, and provide inkjet printers including the ink cartridges.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an exploded perspective view of an ink cartridge 10 according to a first example embodiment of the present invention.

FIG. 2 is a cross-sectional view taken along the II-II line in FIG. 1.

FIG. 3 is an enlarged view of the main part in FIG. 2.

FIGS. 4A to 4E are schematic diagrams showing other aspects of the plate, with FIG. 4A showing the plate being L-shaped in the cross-sectional view, FIG. 4B showing the plate being U-shaped in the cross-sectional view, FIG. 4C showing the plate being square-shaped in the cross-sectional view, FIG. 4D showing the plate having an aspect of FIG. 4B trimmed, and FIG. 4E showing the plate having an aspect of the end shown in FIG. 4B folded.

FIGS. 5A to 5C are schematic diagrams respectively showing in FIG. 5A a plate 90 provided with an aperture 90a, showing in FIG. 5B a plate 91 provided with a notch 91a, and showing in FIG. 5C a plate 92 provided with notches 92a, 92b.

FIG. 6 is a cross-sectional view having another aspect of a plate and corresponding to FIG. 2 including an ink cartridge 100 according to a second example embodiment of the present invention.

FIG. 7 is a schematic diagram showing a plate in which a square-shaped folded portion in a cross-sectional view is formed on the end side of the plate.

FIG. 8 is a perspective view of an inkjet recording device 130 according to the first example embodiment of the present invention.

FIG. 9 is a schematic diagram of an ink supply system 150 of the inkjet recording device 50.

FIGS. 10A to 10B are schematic diagrams showing the arrangement of the ink cartridge 10 in an ink cartridge case 136, with FIG. 10A a high ink state and FIG. 10B a low ink state.

### DETAILED DESCRIPTION OF THE EXAMPLE EMBODIMENTS

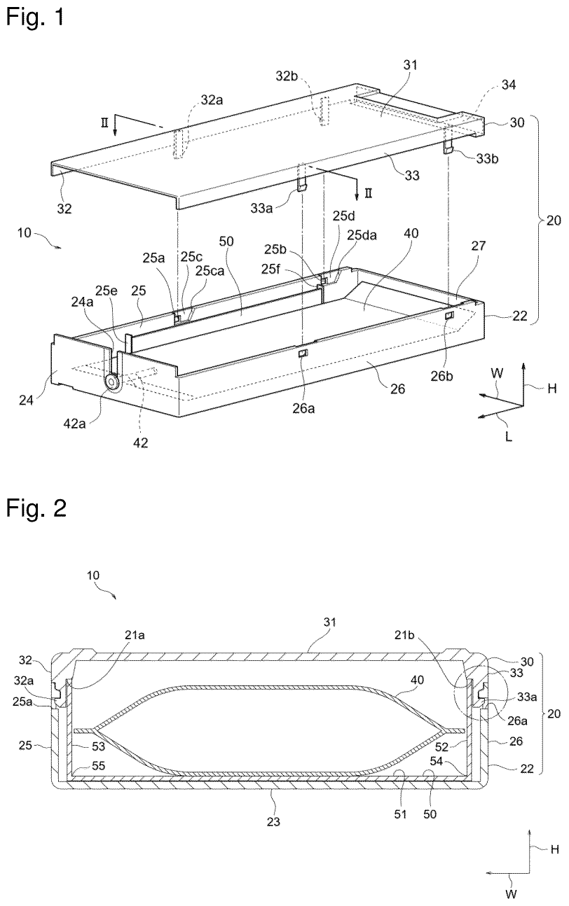

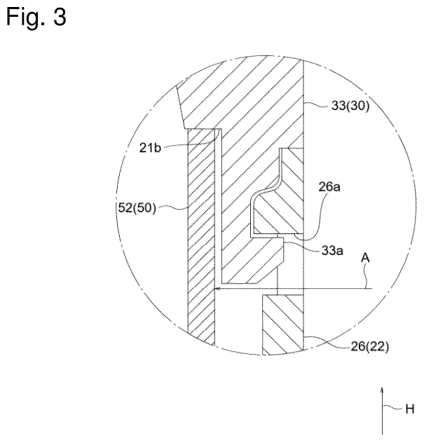

Next, an ink cartridge 10 according to a first example embodiment of the present invention will be described with reference to FIGS. 1 to 3. FIG. 1 is an exploded perspective view of the ink cartridge 10 according to the first example embodiment of the present invention, FIG. 2 is a cross-sectional view taken along the II-II line in FIG. 1, and FIG. 3 is an enlarged view of the main part in FIG. 2. In each figure, the arrow H indicates the height direction, the arrow W indicates the width direction, and the arrow L indicates the length direction. Also, in each figure, the upward direction in the height H direction refers to the arrow direction, the downward direction in the height H direction refers to the opposite direction, the far side direction of the width W refers to the arrow direction, the near side direction of the width W refers to the opposite direction, the forward direction in the length L direction refers to the arrow direction, and the backward direction in the length L direction refers to the opposite direction.

As shown in the figures, the ink cartridge 10 according to the first example embodiment of the present invention includes a box body 20, a bag body 40, and a plate 50.

As shown in FIG. 1, the box body 20 is a rectangular or substantially rectangular box body in which the width W and the length L are wider than the height H, and includes a box main body 22 and a lid 30.

In the present example embodiment, the box main body 22 includes a substantially rectangular bottom wall 23 (see FIG. 2), a front wall 24, a side wall 25, a side wall 26 opposing the side wall 25, and a rear wall 27. Each of the front wall 24, the side wall 25, the side wall 26, and the rear wall 27 stand upward from an end edge of the bottom wall 23. As shown in FIG. 1, the front wall 24 protrudes slightly more than the side wall 25, the side wall 26, and the rear wall 27 in the height H direction, and the side wall 25, the side wall 26, and the rear wall 27 have the same or approximately the same height. Thus, the box main body 22 is a bottomed box main body (the bottom part is the upper surface of the bottom wall 23) including, on its top surface, an aperture surrounded by each upper side of the front wall 24, the side wall 25, the side wall 26, and the rear wall 27.

The front wall 24 has a U-shaped groove 24a at the middle position in the width W direction, into which a spout 42 of the bag body 40 which will be described hereinafter is attached from upward in the height H direction.

The side wall 26 on the near side of the width W in FIG. 1 is provided with rectangular or substantially rectangular holes 26a, 26b, respectively at a position slightly forward of the center in the length L direction and upward in the height H direction, and at a position backward in the length L direction and upward in the height H direction.

The side wall 25 on the far side of the width W is also provided with holes 25a, 25b respectively at positions opposing the holes 26a, 26b. The portions of the holes 25a, 25b back in the length L direction of the side wall 25 are thin-walled portions 25c, 25d which are gouged at the near side in the width W direction. Difference in thickness of the thin-walled portions 25c, 25d finally reduces at the position backward in the length L direction by inclined surfaces 25ca, 25da which rise upward in the height H direction as they extend backward in the length L direction.

Although not shown in FIG. 1, the side wall 26 is also provided with thin-walled portions 26c, 26d at the positions opposing the thin-walled portions 25c, 25d, and with inclined surfaces 26ca, 26da at the positions opposing the inclined surfaces 25ca, 25da.

Furthermore, the side wall 25 on the far side in the width W direction in FIG. 1 is provided with ribs 25e, 25f protruding in the near side direction of the width W respectively at a position on the forward side in the length L direction and a position adjacent to the hole 25b. Similarly, the side wall 26 is provided with ribs 26e, 26f protruding in the far side direction of the width W respectively at positions opposing the ribs 25e, 25f.

Next, the lid 30 will be described. As shown in FIG. 1, the lid 30 is provided with a ceiling wall 31 with a size that corresponds to the bottom wall 23 of the box main body 22, a side frame 32, a side frame 33 opposing the side frame 32, and a rear frame 34. The side frame 32, the side frame33 and the rear frame 34 stand downward from the end edge of the ceiling wall 31. There is no frame forward in the length L direction of the ceiling wall 31. The heights of the side frame 32, the side frame 33 and the rear frame 34 are respectively approximately the same as the difference in the height between the front wall 24 and the side walls 25, 26 and the rear wall 27 of the box main body 22.

The side frame 33 of the lid 30 is provided with claw portions 33a, 33b protruding further downward in the height H direction from the lower end of the side frame 33, respectively at the positions corresponding to the holes 26a, 26b of the side wall 26 in the length L direction. Similarly, the side frame 32 of the lid 30 is provided with claw portions 32a, 32b protruding further downward in the height H direction from the lower end of the side frame 32, respectively at the positions corresponding to the holes 25a, 25b of the side wall 25 in the length L direction.

In the present example embodiment, the bag body 40 has a structure including two rectangular films of the same size or substantially the same size laminated together at their respective edges. A cylindrical spout 42 is inserted about halfway into the bag body 40 at a central position in the width W direction on the short side forward in the length L direction in FIG. 1. A stopper 42a is attached to the end forward in the length L direction of the spout 42. The bag body 40 is including ink inside.

In the present example embodiment, the size of the bag body 40 is slightly shorter than the lengths in the length L direction and the width W direction of the bottom wall 23 of the box main body 22.

Next, the plate will be described. In an example embodiment of the present invention, the plate includes at least one folded portion and a first flat portion and other flat portion formed by folding at the folded portion. In the present example embodiment, a plate 50 is a plate which is formed by folding a rectangular or substantially rectangular flat plate from the both end sides in the short-side direction at an angle of 90 degrees in the same direction so that the folds are parallel and which has three flat portions with a U-shape in the cross-sectional view and two folded portions (see FIG. 2). As shown in FIG. 2, the three flat portions include a first flat portion 51, a second flat portion 52 and a third flat portion 53 positioned on opposite sides across the first flat portion 51. The two folded portions are a folded portion 54 between the first flat portion 51 and the second flat portion 52 and a folded portion 55 between the first flat portion 51 and the third flat portion 53.

As shown in FIG. 2, the width of the first flat portion 51 is shorter than the length between the side wall 25 and the side wall 26 in the width W direction in FIG. 2 and is longer than the length of the bag body 40 in the short-side direction. The length of the first flat portion 51 is snugly long enough to fit between the ribs 25e to 25f of the side wall 25 and between the ribs 26e to 26f of the side wall 26 in the length L direction in FIG. 1.

The lengths of the second flat portion 52 and the third flat portion 53 are the same as the length of the first flat portion 51 in the length L direction in FIG. 1. The heights of the second flat portion 52 and the third flat portion 53 are approximately the same as the heights of the side wall 25 and the side wall 26 of the box main body 22 in the height H direction in FIG. 2.

Accordingly, the plate 50 is fitted into the box main body 22 between the ribs 25e to 25f of the side wall 25 and between the ribs 26e to 26f of the side wall 26. As shown in FIG. 1, the bag body 40 is placed in the box main body 22 in the state where the spout 42 is attached to the U-shaped groove 24a of the box main body 22 from upward in the height H direction. Then, the bag body 40 is adhered to the upper surface of the first flat portion 51 from a position in the vicinity of the farthest side to a position in the vicinity of the nearest side of the width W of the bag body 40 in FIG. 1.

Next, the attachment of the lid 30 to the box main body 22 will be described. A closed box body 20 is formed by engaging the claw portions 32a, 32b of the side frame 32 and the claw portions 33a, 33b of the side frame 33 of the lid 30 respectively to the holes 25a, 25b of the side wall 25 and the holes 26a, 26b of the side wall 26 outward from the inside of the box main body 20 (see FIGS. 2 and 3).

To open the box body 20, the lid 30 may be slid backward in the length L direction with respect to the box main body 22, as shown in FIG. 1. As a result, the claw portions 32a, 32b of the side frame 32 and the claw portions 33a, 33b of the side frame 33 move out of the holes 25a, 25b of the side wall 25 and the holes 26a, 26b of the side wall 26, and move to the thin-walled portions 25c, 25d of the side wall 25 and the thin-walled portions 26c, 26d of the side wall 26 positioned backward in the length L direction. Further, the claw portions 32a, 32b and the claw portions 33a, 33b move upwardly while sliding on the inclined surfaces 25ca, 25da on the side wall 25 and on the inclined surfaces 26ca, 26da on the side wall 26 backward in the length L direction to quickly open the box body 20. The opening/closing of the lid 30 is not limited to the sliding mechanism of sliding the lid 30 backward in the length L direction with respect to the box main body 22, but can also be the performed by lifting the lid 30 upward in the height H direction shown in FIG. 1 to open the lid 30 of the box body 20, or by providing a hinge to open and close the lid 30 at the upper end of the side wall 25. The well-known opening/closing mechanism of the box body 20 can be adopted.

Thus, according to the ink cartridge 10 of the present example embodiment, the upper end of the second flat portion 52 and the upper end of the third flat portion 53 of the plate 50 are disposed in contact with the corner portions 21a, 21b of the box main body 22 and the lid 30 when the box body 20 is closed, and the first flat portion is disposed in contact with the bottom surface of the box main body 22. Therefore, the contact state of the first flat portion 51 with the bottom surface of the box main body 22 can be easily released by opening the lid 30. In other words, opening/closing of the box body 20 releases/fixes the fixed installation of the first flat portion 51 to which the bag body 40 is adhered, to the box main body 22 to make it easy for general users to replace the bag body 40 (ink).

In addition, since the bag body 40 including ink is held by the plate 50 which is folded twice, the rigidity of the plate 50 can be increased compared to using a conventional single-plate fixing plate, and thus the material of the plate 50 can be substituted with a material with lower rigidity than the conventional one, such as coated cardboard.

Furthermore, as shown in FIG. 3, a gap exists in a portion of the closed box body 20, that is, in the engagement portion between the claw portion 33a of the side frame 33 of the lid 30 and 26a of the side wall 26 of the box main body 22. A light-shielding structure such as coated cardboard is employed as the plate 50, and the second flat portion 52 of the plate 50 is disposed in the position to block the gap when the box body 20 is closed to block light in the arrow A direction entering the box body 20 through the gap of the box body 20.

Light-curing resin is sometimes usable as ink in the bag body. In such cases, there is a risk that light entering the box body from a gap of the box body may cause the ink in the bag body to cure or the viscosity of the ink to increase. However, according to the present example embodiment, light in the arrow A direction entering the box body 20 through the gap can be blocked, and the curing or increase in viscosity of the ink can be prevented even when light-curing resin is employed as the ink of the bag body 40.

Moreover, the plate 50 is positioned by the ribs 25e, 25f, 26e, 26f provided in the box main body 22 to prevent displacement of the plate 50 not only in the width W direction and the height H direction in FIG. 1, but also in the length L direction in FIG. 1.

The present invention is not limited to the above example embodiments, and can be changed in various ways without departing from the spirit of the present invention.

For example, in the above example embodiments, the plate 50 includes three flat portions 51, 52, 53 which are U-shaped in the cross-sectional view, and two folded portions 54, 55, but is not limited thereto. As described above, the plate may include at least one folded portion and a first flat portion and other flat portion formed by folding at this folded portion.

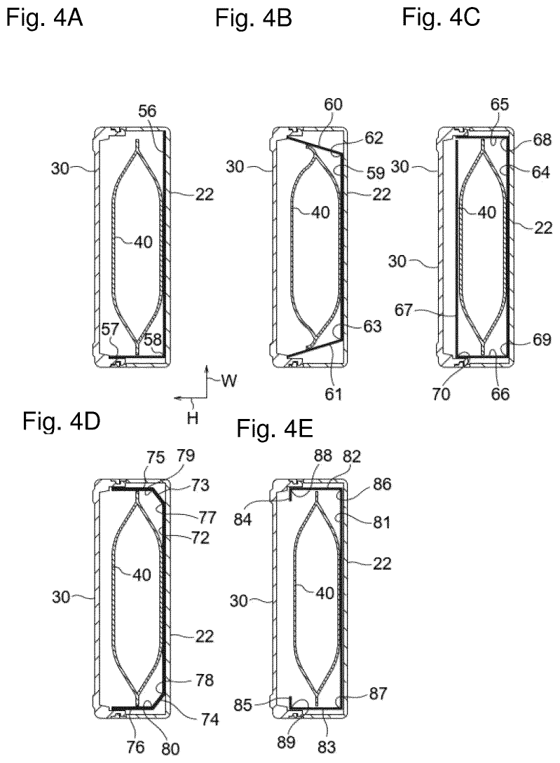

FIGS. 4A to 4E are schematic diagrams showing other aspects of the plate. The plate in FIG. 4A is an L-shaped plate in the cross-sectional view having a first flat portion 56, a second flat portion 57, and a folded portion 58. In FIG. 4A, the arrow W indicates the width direction and the arrow H indicates the height direction. The arrows W and H in FIGS. 4B to 4E are omitted. The plate in FIG. 4B is a U-shaped plate in the cross-sectional view having a first flat portion 59, a second flat portion 60, a third flat portion 61, and folded portions 62, 63. In FIG. 4B, the angle defined by the first flat portion 59 and the second flat portion 60, and the angle defined by the first flat portion 59 and the third flat portion 61 are obtuse angles greater than 90 degrees.

The plate in FIG. 4C is a square-shaped plate in a cross-sectional view having a first flat portion 64, a second flat portion 65, a third flat portion 66, a fourth flat portion 67, and folded portions 68, 69, 70. In FIG. 4C, both flat portions 65, 67 may be joined at the contact of the second flat portion 65 and the fourth flat portion 67. The plate in FIG. 4D is a plate having a first flat portion 72, a second flat portion 73, a third flat portion 74, a fourth flat portion 75, a fifth flat portion 76, and folded portions 77, 78, 79, 80. The shape is such that the corner portions of the folded portions 54, 55 of the plate 50 of the first example embodiment are trimmed.

The plate in FIG. 4E includes a first flat portion 81, a second flat portion 82, a third flat portion 83, a fourth flat portion 84, a fifth flat portion 85, and folded portions 86, 87, 88, 89. The shape can be such that the tips upward in the height H direction of the second flat portion 52 and the third flat portion 53 of the plate 50 are folded farther inward in the width W direction.

Furthermore, the plates in FIGS. 4C to 4E may include four or more flat portions by folding at least three times in the same direction at folds that do not intersect.

In any plate shown in FIGS. 4A to 4E, the end of the other flat portion is in contact with the corner portions of the box main body 22 and the lid 30, which restrains the behavior of the plate and the bag body 40 adhered to the plate (specifically, the first flat portion) in the height H direction and the width W direction, and allows the bag body 40 including ink to be fixed to the box main body 22.

In example embodiments of the present invention, the fact that the end of the other flat portion is in contact with the corner portion of the box main body 22 and the lid 30 does not mean that the end of the other flat portion must necessarily be in contact with both of the box of the box main body 22 and the lid 30 at this corner part. For example, as shown in FIG. 2, when the side frame 33 extends downward from the end edge of the ceiling wall 31 of the lid 30 and the side wall 26 of the box main body 22 is positioned outside thereof, the end of the other flat portion (the second flat portion 52) may only be in contact with the lid 30 at the corner portion.

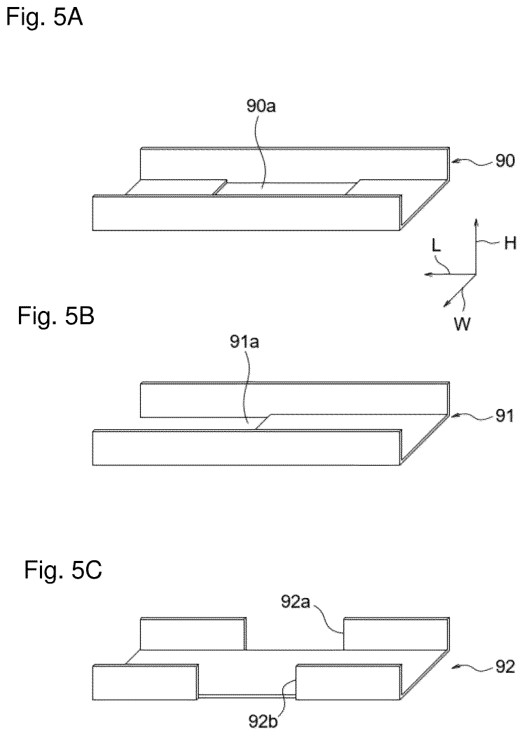

Although the plate 50 according to the present example embodiment does not have apertures or notches, the plate may be provided with apertures and/or notches in an example embodiment of the present invention. FIGS. 5A to 5C are schematic diagrams respectively showing in FIG. 5A a plate 90 provided with an aperture 90a, showing in FIG. 5B a plate 91 provided with a notch 91a, and showing in FIG. 5C a plate 92 provided with notches 92a, 92b. In FIG. 5A, the arrow H indicates the height direction, the arrow L indicates the length direction, and the arrow W indicates the width direction. The arrows H, L and H in FIGS. 5B to 5C are omitted.

As shown in FIG. 5A, the plate 90 includes a rectangular or substantially rectangular aperture 90a at a central position in the length L direction of the first flat portion. As shown in FIG. 5B, the plate 91 has a rectangular or substantially rectangular notch 91a forward in the length L direction of the first flat portion. As shown in FIG. 5C, the plate 92 has rectangular or substantially rectangular notches 92a, 92b respectively at the central position in the length L direction of the second flat portion and the third flat portion.

By providing apertures and/or notches as shown in the plates 90 to 92, it is possible to reduce the amount of material used and reduce costs.

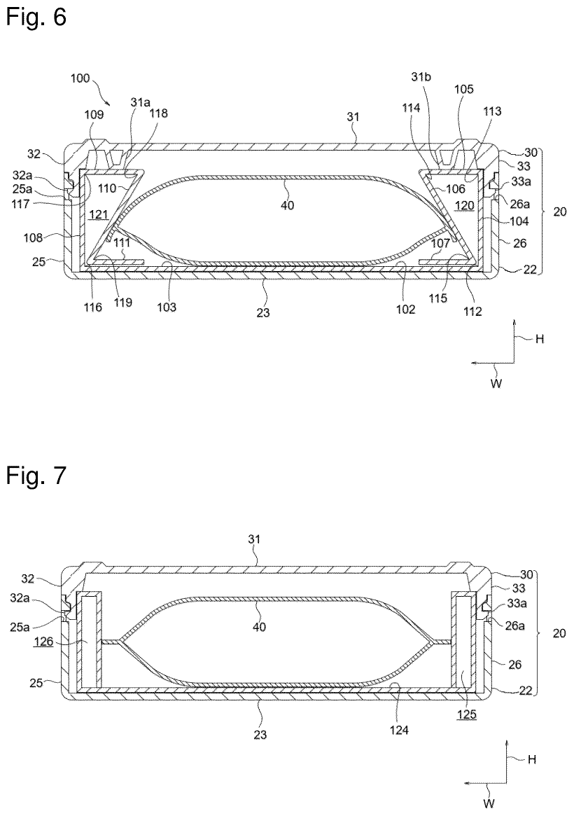

Furthermore, a plate may be folded in the same direction multiple times respectively on the both end sides of the plate to define mutually parallel or substantially parallel sides to form polygonal folded portions in a cross-sectional view. FIG. 6 is a cross-sectional view having another aspect of a plate and corresponding to FIG. 2 having an ink cartridge 100 according to the second example embodiment of the present invention. In the present example embodiment, the description of the same portions as in the first example embodiment is omitted.

As shown in FIG. 6, a plate 102 includes a first flat portion 103, a second flat portion 104, a third flat portion 105, a fourth flat portion 106, and a fifth flat portion 107, has the sixth to ninth flat portions 108 to 111 corresponding to the second to fifth flat portions, and has folded portions 112 to 119 as shown.

Accordingly, the plate 102 is folded in the same direction three times respectively on the both end sides of the plate 102 to define mutually parallel or substantially parallel sides to form a triangular folded portion 120 in a cross-sectional view. Among the second flat portion 104, the third flat portion 105, and the fourth flat portion 106 defining the triangular folded portion 120 in the cross-sectional view, the third flat portion 105 opposes the ceiling wall 31 of the lid 30. The same applies to the folded portion 121, the description of which is omitted.

In the present example embodiment, cylindrical protrusions 31a, 31b protruding downward in the height H direction are provided on the lower surface of the ceiling wall 31 of the lid 30. The protrusions protrude to the height position of the corner portions 21a, 21b of the box main body 22 and the lid 30 (see FIGS. 2 and 3).

Accordingly, by providing the triangular folded portions 120, 121 in the cross-sectional view on the end sides of the plate 102, the pressing force from the lid 30 can be concentrated on the both ends of the first flat portion 103 in the width W direction shown in FIG. 6, so that the first flat portion 103 is not only pressed from upward in the height H direction in FIG. 6, but also pulled in the width W direction on the both ends. Thus, the bag body adhered to the first flat portion 103 can be firmly fixed to the bottom portion (bottom wall 23) of the box main body 22 via this first flat portion 103.

Besides, as shown in FIG. 6, the third flat portion 105 and the seventh flat portion 109 oppose the ceiling wall 31 of the lid 30, and the third flat portion 105 and the seventh flat portion 109 are respectively in contact with the protrusions 31a, 31b when the box body 20 is closed. Therefore, the pressing pressure can be reliably and stably applied to the first flat portion 103 to more effectively suppress the clearance of the plate 102 to which the bag body 40 is fixed, within the box body 20.

In the above second example embodiment, the folded portions 120, 121 of the plate 102 are triangular in the cross-sectional view, but are not limited to this. FIG. 7 is a schematic diagram showing a plate in which square-shaped folded portions in a cross-sectional view are on the end sides of the plate. As shown in the figure, the plate 124 is folded in the same direction three times respectively on the both end sides of the plate 124 to define mutually parallel or substantially parallel sides to define rectangular folded portions 125, 126 in the cross-sectional view.

Furthermore, in the above first example embodiment, by making the length of the first flat portion 51 of the plate 50 snugly fit between the ribs 25e to 25f of the side wall 25 and the ribs 26e to 26f of the side wall 26 in the length L direction in FIG. 1, the first flat portion 51 is positioned in the box main body 22. However, the ribs 25e to 26f and 26e to 26f are not essential. In the absence of these ribs, it is preferable that, the flat portion is disposed so that the lengths in two different directions (in the width W direction and the length L direction in FIG. 1) of the surface of the first flat portion 51 when viewed from a direction perpendicular to the surface of the first flat portion 51 (in the height H direction in FIG. 1) are equal or substantially equal to the lengths in two different directions in the area where the flat portion inside the box body 20 is disposed when viewed from the direction perpendicular to the surface of the first flat portion 51 (in the width W and length L directions in FIG. 1).

According to this configuration, the first flat portion 51 of the plate 50 snugly fits within the box body 20, and the behavior of the first flat portion 51 (and the bag body 40 adhered to the first flat portion 51) in the width W direction and the length L direction in FIG. 1 is restrained.

In yet another aspect, an example embodiment of the present invention provides an ink cartridge including a box body including a box main body with an aperture and a lid covering the aperture, and a bag body inside the box body and including ink inside, the ink cartridge includes a plate including at least one folded portion and a first flat portion and other flat portion formed by folding at the folded portion, the bag body is adhered to one side surface of the first flat portion, and at least a portion of the other flat portion is positioned on the one side surface, and a length of the other flat portion when viewed from a direction parallel to the surface of the first flat portion in the state where the plate and the bag body are in the box body is equal to a length in an area in which the flat portion is disposed inside the box body when viewed from a direction parallel to the surface of the first flat portion.

An ink cartridge according to this example embodiment can also provide an ink cartridge that allows ink to be easily replaced and that includes a fixing plate which allows an ink pouch to be fixed even if a plate material has poor rigidity.

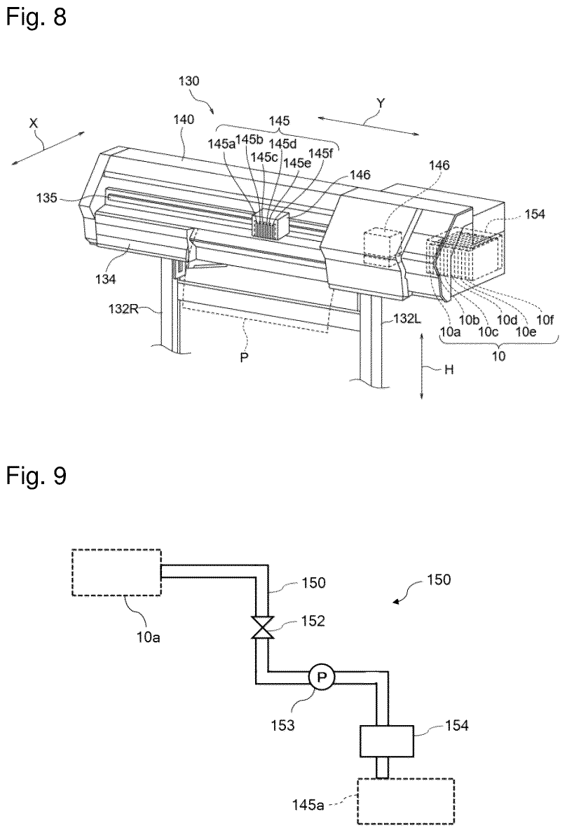

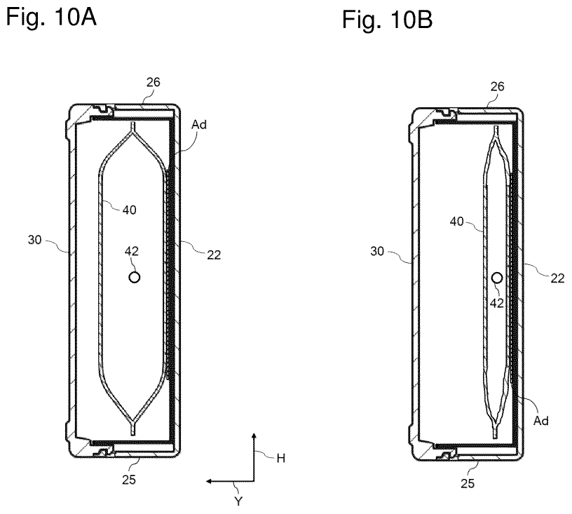

Next, an inkjet recording device according to an example embodiment of the present invention will be described with reference to FIGS. 8 to 10A and 10B. FIG. 8 is a perspective view of the inkjet recording device 130 according to the first example embodiment of the present invention. FIG. 9 is a schematic diagram of an ink supply system 150 of the inkjet recording device 50. FIGS. 10A and 10B are schematic diagrams showing the arrangement of the ink cartridge in an ink cartridge case, with FIG. 10A showing a high ink state and FIG. 10B showing a low ink state. In FIGS. 8 and 10A and 10B, the arrow Y is referred to as a main scanning direction, the arrow X is referred to as the secondary scanning direction, and the arrow H is referred to as the height direction. In FIG. 9, the ink supply system 150 is an example of an ink supply system between an ink cartridge 10a and an ink head 145a.

The inkjet recording device 130 according to the present example embodiment includes the ink cartridge 10 according to the above first example embodiment, an ink head 145 to discharge ink included in the ink cartridge 10, an ink supply system 150 to guide the ink filled in the ink cartridge to the ink head 145.

The inkjet recording device 130 includes a main body portion 134, a main body case 140, a right leg portion 132R, a left leg portion 132L, an ink head unit 146, and an ink cartridge case 136. The main body portion 134 has a main scanning direction Y as its long-side direction. The right leg portion 132R and the left leg portion 132L are attached to the lower portion of the main body portion 134 to support the main body portion 134.

The main body portion 134 is provided with a guide rail 135 extending in the main scanning direction Y. The ink head unit 146 is attached to the guide rail 135 via a carriage (not shown). The ink head unit 146 moves back and forth along the guide rail 135 in the main scanning direction.

A recording paper P is disposed on the main body portion 134 at a position opposing the ink head unit 146.

The ink cartridge case 136 is disposed in the main body case 140 at the right-side position in the main scanning direction Y of the main body portion 134. A plurality of (for example, six in the present example embodiment) ink cartridges 10 are disposed horizontally in the ink cartridge case 136 to be arranged side by side, as shown in FIG. 10A, with the side wall 25 of the box main body 22 opposing downward at the height H direction in FIG. 8, and the side wall 26 opposing upward in the height H direction in FIG. 8.

In the six ink cartridges 10 (respectively 10a to 10f, see FIG. 8), the bag body 40 may include inks of different colors.

The ink head unit 146 is equipped with six ink heads 145a to 145f (see FIG. 8), each of which discharges the inks of different colors onto the recording paper P using an inkjet method. Although not shown, on the lower surface of the six ink heads 145a to 145f, a plurality of inkjet nozzles being discharge ports to discharge ink onto the recording paper P are provided downward in the height H direction to oppose the recording paper P.

The ink supply system 150 is an ink supply system that supplies ink from the ink cartridges 10a to 10f to the ink heads 145a to 145f. As shown in FIG. 9, the ink supply system includes an ink path 151, a valve 152, a supply pump 153, and a damper 154. The supply pump is an example of an ink supply system. As shown in FIG. 9, the ink head 145a and damper 154 are mounted on a carriage (not shown) and move back and forth in the main scanning direction Y.

On the other hand, the ink cartridge 10a is not mounted on the carriage and does not move back and forth in the main scanning direction Y. Therefore, most of the ink path 151 (at least half of its total length) extends in the main scanning direction Y so that the ink path 151 is not damaged when the carriage moves in the main scanning direction Y. In the present example embodiment, a total of six ink paths 151 preferably are provided, for example.

According to the inkjet recording device 130 of the present example embodiment, ink in the ink cartridges 10a to 10f can be supplied to the ink heads 146a to 146f via the ink supply system 150 to enable to record on the recording paper P.

Furthermore, when the ink in the ink cartridge 10 runs out, the user takes out the ink cartridge 10 from the ink cartridge case 136. As already described, opening/closing of the box body 20 releases/fixes the fixed installation of the first flat portion 51 to which the bag body 40 is adhered, to the box main body 22 to make it easy to replace the bag body 40 (ink).

Furthermore, in the ink cartridge case 136, as shown in FIG. 10A, the ink cartridge 10 is disposed horizontally with the side wall 25 of the box main body 22 opposing downward in the height H direction in FIGS. 10A and 10B, and the side wall 26 opposing upward in the height H direction in FIG. 10A. The bag body 40 is disposed on the upper surface of the first flat portion 51. An adhesive portion Ad is located from a position in the vicinity of the farthest side to a position in the vicinity of the nearest side of the width W of the bag body 40 in FIG. 1, that is, in the position from the vicinity of the upper end to the vicinity of the lower end in the height H direction in FIG. 10A.

In the ink cartridge 10 in FIG. 10A, since the pigments in the ink generally sink downward in the height H direction, the ink is thicker at the lower portion of the bag body 40, thinner at the upper part, and maintained at just the right density in the center therebetween. The spout 42 is in the center in the height H direction in FIGS. 10A and 10B so that the ink with the right density can be supplied to the ink head 145 via the ink supply system 150.

Furthermore, when the ink in the ink cartridge 10 is used and the ink in the bag body 40 decreases, as shown in FIG. 10B, the volume of the bag body 40 decreases and the entire bag body 40 shifts toward the first flat portion 51. However, in the bag body 40, the adhesive portion Ad is made in the position from the vicinity of the upper end to the vicinity of the lower end in the height H direction in the bag body in FIGS. 10A and 10B, so that the ink can be supplied from the center in the height H direction of the bag body 40 to the end, and thus the ink with the right density in the bag body 40 can be used up to the end. This is because the fact that the first flat portion 51 is stably fixed to the bottom wall 23 when the box body 20 is closed, and the bag body 40 is fixedly installed on the bottom wall 23 via the first flat portion 51.

In FIGS. 10A and 10B, the bag body 40 is adhered to the upper surface of the first flat portion 51 from a position in the vicinity of the farthest side to a position in the vicinity of the nearest side of the width W of the bag body 40 in FIG. 1 (i.e., the adhesive portion Ad is made in the position from the vicinity of the upper end to the vicinity of the lower end of the height H direction in FIG. 10A). However, the bag body 40 does not necessarily have to be adhered from a position in the vicinity of the farthest side to a position in the vicinity of the nearest side of the width W in FIG. 1. The inventors have confirmed that if the bag body 40 is adhered to the first flat portion 51 within at least ⅘ in the length in the short-side direction of the bag body 40, with the center position of the adhesive portion in the height direction of the bag body 40 in FIGS. 10A and 10B, the ink with an acceptable density which is neither too thick nor too thin in the bag body 40 can be used up from start to the end.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An ink cartridge comprising:
a box body including a box main body with an aperture and a lid covering the aperture, and a bag body installed inside the box body and including ink inside; wherein
the ink cartridge includes a plate including at least one folded portion and a first flat portion and other flat portion(s) defined by at least one fold at the folded portion;
the bag body is adhered to one side surface of the first flat portion; and
at least a portion of the other flat portion(s) is positioned on the one side surface, and a length of the other flat portion(s) when viewed from a direction parallel to the one side surface of the first flat portion in a state where the plate and the bag body are in the box body is equal to a length of an area in which the flat portion is inside the box body when viewed from a direction parallel to the one side surface of the first flat portion.

2. The ink cartridge according to claim 1, wherein
the plate is a plate including three flat portions defined by two folded portions that do not intersect;
the other flat portions include a second flat portion and a third flat portion positioned on opposite sides across the first flat portion; and
when the box body is closed, an end of the second flat portion and an end of the third flat portion are respectively in contact with mutually opposing corner portions of the box main body and the lid.

3. The ink cartridge according to claim 1, wherein
when the box body is closed, a gap exists in a portion of the closed box body;
the plate is made of a light-shielding material and is positioned to block the gap when the box body is closed.

4. The ink cartridge according to claim 1, wherein the plate is folded in a same direction multiple times respectively on both end sides of the plate to define mutually substantially parallel sides to define polygonal folded portions in a cross-sectional view.

5. The ink cartridge according to claim 4, wherein the plate is folded three times in the same direction respectively on the both end sides of the plate to define mutually substantially parallel sides to define triangular folded portions in the cross-sectional view.

6. The ink cartridge according to claim 5, wherein at least one surface of the other flat portion(s) defining triangular folded portions in the cross-sectional view opposes the lid.

7. The ink cartridge according to claim 4, wherein the plate is folded in a same direction multiple times respectively on the both end sides of the plate to define mutually substantially parallel sides to define square-shaped folded portions in a cross-sectional view.

8. The ink cartridge according to claim 1, wherein the plate includes four or more flat portions defined by folds in a same direction folded at least three times at folds that do not intersect.

9. An inkjet recording device comprising:
the ink cartridge according to claim 1;
an ink head to discharge ink in the ink cartridge; and
an ink supply system to guide the ink in the ink cartridge to the ink head.

10. An ink cartridge comprising:
a box body including a bottomed box main body with an aperture on a top surface and a lid covering the aperture, and a bag body fixedly installed inside the box main body and including ink inside; wherein
the ink cartridge includes a plate including at least one folded portion and a first flat portion and other flat portion(s) defined by at least one fold at the folded portion;
the bag body is adhered to an upper surface of the first flat portion; and
when the box body is closed, an end of the other flat portion(s) is in contact with a corner portion of the box main body and the lid, and the first flat portion is in contact with the bottom surface of the box main body.

11. The ink cartridge according to claim 10, wherein
the plate is a plate including three flat portions defined by two folded portions that do not intersect;
the other flat portions include a second flat portion and a third flat portion positioned on opposite sides across the first flat portion; and
when the box body is closed, an end of the second flat portion and an end of the third flat portion are respectively in contact with mutually opposing corner portions of the box main body and the lid.

12. The ink cartridge according to claim 10, wherein
when the box body is closed, a gap exists in a portion of the closed box body;
the plate is made of a light-shielding material and is positioned to block the gap when the box body is closed.

13. The ink cartridge according to claim 10, wherein the plate is folded in a same direction multiple times respectively on both end sides of the plate to define mutually substantially parallel sides to define polygonal folded portions in a cross-sectional view.

14. The ink cartridge according to claim 13, wherein the plate is folded three times in the same direction respectively on the both end sides of the plate to define mutually substantially parallel sides to define triangular folded portions in the cross-sectional view.

15. The ink cartridge according to claim 14, wherein at least one surface of the other flat portion(s) defining triangular folded portions in the cross-sectional view opposes the lid.

16. The ink cartridge according to claim 15, wherein the plate is folded in a same direction multiple times respectively on the both end sides of the plate to define mutually substantially parallel sides to define square-shaped folded portions in a cross-sectional view.

17. The ink cartridge according to claim 10, wherein the plate includes four or more flat portions defined by folds in a same direction folded at least three times at folds that do not intersect.

18. An inkjet recording device comprising:
the ink cartridge according to claim 10;
an ink head to discharge ink in the ink cartridge; and
an ink supply system to guide the ink in the ink cartridge to the ink head.
